(19) United States
(12) Patent Application Publication
(10) Pub. No.: US 2021/0163005 A1
(43) Pub. Date: Jun. 3, 2021

(54) PRIME MOVER AND METHOD FOR OPERATING A PRIME MOVER

(71) Applicant: CLAAS Tractor SAS, VéIizy-VilIacoublay (FR)

(72) Inventors: Christian Ehlert, Bielefeld (DE); Jan Carsten Wieckhorst, Paderborn (DE); Christian Birkmann, Versmold (DE); Robin Schütte, Büren (DE); Ralf Müller, Schonbeck (DE); Dennis Neitemeier, Lippetal (DE)

(73) Assignee: CLAAS Tractor SAS, VéIizy-VilIacoublay (FR)

(21) Appl. No.: 17/104,530

(22) Filed: Nov. 25, 2020

(30) Foreign Application Priority Data
Nov. 29, 2019 (DE) 102019132547.1

(51) Int. Cl. B60W 30/18; B60W 50/04; B60W 10/10

(52) U.S. Cl. CPC B60W 30/18009; B60W 2050/0041; B60W 10/10; B60W 50/045

(57) ABSTRACT

A prime mover and a method for operating a prime mover are disclosed. The prime mover, which may be a tractor, includes a drivetrain and is configured to attach to an attachment. The drivetrain includes at least one drive motor, a gearbox, at least one power take-off, and at least one ancillary unit. The prime mover has a driver assistance system that controls the drivetrain and that includes a computing unit, a memory unit, and an input/output unit. The driver assistance system comprises an engine droop governor that works based on a characteristic curve, wherein the engine droop governor is configured for optimized control of the drivetrain depending on selectable control strategies saved in the memory unit and/or optimization target variables.

### CROSS REFERENCE TO RELATED APPLICATION

This application claims priority under 35 U.S.C. § 119 to German Patent Application No. DE 102019132547.1 (filed Nov. 29, 2019), the entire disclosure of which is hereby incorporated by reference herein.

### TECHNICAL FIELD

The invention relates to a prime mover, such as tractor. More specifically, the invention relates to a driver assistance system for controlling the drivetrain of the prime mover and method for operating the prime mover.

### BACKGROUND

A prime mover, in particular an agricultural prime mover such as a tractor, may include a drivetrain and at least one attachment adapted to or configured to be connected with the prime mover. The drivetrain comprises at least one drive motor, a gearbox, at least one ancillary unit, and at least one power take-off. For its operation, a drive motor, which may be designed as an internal combustion engine, is assigned an engine control unit, which controls one or more aspects of the drive motor. For example, the engine control unit may control the engine rotational speed based on a fuel consumption characteristic map specific to the internal combustion engine. The gearbox has a gearbox control unit that adjusts gearbox ratios, or respectively shifting rotational speeds of the gearbox. An operator may specify the engine rotational speed or the gearbox ratio, such as through an operator control device. The attachment adapted to the prime mover (e.g., coupled, connected, or mounted to the prime mover) may be pulled or pushed by the prime mover. With the attachment adapted to the prime mover, an arrangement of the attachment semi-mounted on the frame structure of the prime mover is also contemplated. The engine control unit adjusts the operating point corresponding to the specification by the operator at full load such that the operating point lies either around the maximum engine performance, or around the minimum fuel consumption.

The drivetrain of an agricultural work vehicle may be controlled. See EP 0 698 518 A1 (corresponding to U.S. Pat. No. 5,575,737, incorporated by reference herein in its entirety).

### DESCRIPTION OF THE FIGURES

The present application is further described in the detailed description which follows, in reference to the noted plurality of drawings by way of non-limiting examples of exemplary implementation, in which like reference numerals represent similar parts throughout the several views of the drawings, and wherein:

FIG. 1 shows a schematic representation of a prime mover and an attachment adapted to the prime mover.

FIG. 2 shows a schematic representation of a drivetrain of the prime mover.

FIG. 3 shows a detailed view of a driver assistance system of the prime mover.

FIG. 4 shows an example of an n-dimensional characteristic map for controlling the drivetrain of the prime mover.

FIG. 5 shows an example of an initial characteristic map that is adapted based on a change to the operating parameter in the drivetrain.

### DETAILED DESCRIPTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

Typically, complexities of the drivetrain and/or the attachment are not accounted for in their control. As merely one example, the operator may generally not be familiar with the engine characteristic, and therefore the operator-specified adjustment of the engine rotational speed and/or gearbox ratio may not lie at the optimum operating point. Moreover, other influences on the overall efficiency of the drivetrain may not be unconsidered. As such, in one or some embodiments, the prime mover may be designed such that the complex relationships in improving or optimizing the adjustment of the drivetrain of the prime mover and an adapted attachment may be better considered.

In one or some embodiments, the prime mover includes a driver assistance system with an engine droop governor. Further, in one or some embodiments, a method for operating the prime mover is disclosed.

In one or some embodiments, a prime mover, such as a tractor, includes a drivetrain and includes, or is configured to attach to, at least one attachment. The drivetrain may include at least one drive motor, at least one gearbox, at least one power take-off, and at least one ancillary unit. The prime mover further includes a driver assistance system that is configured to control the drivetrain and that comprises at least one processor (such as a computing unit), at least one memory (such as a memory unit), and an input/output unit. The driver assistance system comprises an engine droop governor that operates based on a characteristic curve, wherein the engine droop governor is configured for optimized control of the drivetrain depending on selectable control strategies (which may be selected from a plurality of available control strategies stored in a memory) and/or optimization target variables saved in the memory. The driver assistance system enables an operator of the prime mover to improve or optimize drivetrain control by selecting a control strategy, and/or one or more optimization target variables without more extensive knowledge of the drivetrain of the prime mover. In so doing, some or all of the relationships in the drivetrain may be taken into account by the engine droop governor that operates based on a characteristic curve which influences the control strategies, or respectively the optimization target variable(s). In contrast to the previous solutions, the influential variables in the drivetrain are also detected and taken into account that influence the optimum operating point of the drive motor, and not merely the operating point specific to the drive motor based on a specific fuel consumption characteristic map. These influential variables are, inter alia, any one or a combination of: the efficiency characteristic of the other components belonging to the drive train; or losses that occur in the drivetrain (e.g., depending on the rotational speed). Advantageously, the engine droop governor may consider dispersions of efficiencies and/or varying operating behavior of the components of the drivetrain that occur in operating practice. Likewise, the dispersions occurring in operating practice of efficiencies of the drivetrain under different conditions of use of the prime mover can also be taken into account. As such, the overall system comprising (or consisting) of the prime mover with the drivetrain and adapted attachment may be comprehensively improved or optimized based on an automated adjustment of the engine droop. The at least one processor, the at least one memory, and the input/output unit of the driver assistance system may be spatially separate from each other (e.g., these components need not be arranged together on the prime mover).

In one or some embodiments, the term “control strategy” describes a superordinate specification of an operating mode of the prime mover without specifying through selecting one or more control variables. The term “optimization target variable” describes a specific objective while specifying one or more control variables that are to be achieved by the engine droop governor's control of the drivetrain. The particular optimization target variable represents a specific subsection of the control strategy whose adaptation is undertaken to achieve and maintain the control strategy.

The at least one drive motor may comprise an internal combustion engine. The drivetrain can additionally comprise another drive motor that, for example, is designed as an electric motor. The gearbox may be designed as a power shift gearbox or continuously variable gearbox. An engine fan, a hydraulic pump, or an electric generator may, for example, form an ancillary unit of the drivetrain. In particular, a PTO shaft may comprise a power take-off shaft that may serve to drive the attachment.

Various attachments are contemplated. For example, the attachment for the prime mover may be designed as: a transport trailer; loading vehicle; windrow; tedder; mower; baler; tillage machine; sprayer; or manure spreader.

In this regard, the drivetrain together with the driver assistance system may form the engine droop governor in that the computing unit is configured to autonomously ascertain parameters of the drivetrain in order to implement the selected control strategy and/or optimization target variable, and to specify them to at least a part of the drivetrain (e.g., to the drive motor and/or the gearbox). The basis for ascertaining the parameters of the drivetrain is the selection (such as by an operator of the prime mover) of one of the control strategies and/or optimization target variables that are saved in the memory unit of the driver assistance system. With the disclosed engine droop governor, a manner of controlling the drivetrain may be specified through a single selection by the operator of the control strategy or optimization target variables. More specifically, further entry by the driver is unnecessary for said ascertainment of the parameters of the drivetrain since they are entered autonomously. However, the operator may be provided the opportunity to, for example, change the selected control strategy and/or an optimization target variable as desired so that autonomous control of the drivetrain subsequently still occurs, but then with a different priority if desired.

In one or some embodiments, the control strategies may be prime mover-specific strategies, and/or attachment-specific strategies.

In particular, the selectable control strategy may comprise at least a control strategy of “efficiency” or “performance”. With the control strategy of “efficiency”, the engine droop governor (such as the computing unit in the driver assistance system) analyzes in order to optimize fuel consumption (e.g., the computing unit analyzes an n-dimensional characteristic map in order to determine the operating point in the n-dimensional characteristic map that lies near the least possible fuel consumption, taking into account the parameters of the drivetrain in order to optimize fuel consumption per unit area; the engine droop governor may then control the drivetrain such that the drivetrain operates according to the determined parameters to optimize fuel consumption per unit area). With the control strategy of “performance”, an optimization of output per area is performed, wherein the operating point in the n-dimensional characteristic map lies near the maximum engine output, taking into account the parameters of the drivetrain. Similarly, the computing unit in the driver assistance system analyzes in order to optimize performance, such as by analyzing the n-dimensional characteristic map in order to determine the operating point in the n-dimensional characteristic map that lies near the maximum engine output, taking into account the parameters of the drivetrain in order to optimize performance, with the engine droop governor controlling the drivetrain accordingly such that the drivetrain operates to maximize engine output. To accomplish this, the engine rotational speed at full load, or the shifting rotational speed of the gearbox may be varied taking into account the parameters of the drivetrain corresponding to the particular control strategy.

The optimization target variables may be any one, any combination, or all of: the “output per area”; “consumption per area”; “yield per area”; “cost per area”; or “work quality”. The optimization target variable of “cost per area” may, for example, primarily include accruing personnel costs, fuel costs, wear costs, operating hours, etc. The optimization target variable of “performance per area” may, for example, primarily concern increasing the worked area and/or processed bulk of agricultural goods. The optimization target variable of “work quality” may prioritize, for example, the admixture of crop residue, crumbling, reconsolidation, feed quality, etc. in controlling the drive train.

In so doing, the parameters to be taken into account for optimized controlling of the drivetrain may be any one, any combination, or all of: the optimization parameters of the drivetrain; the at least one ancillary unit of the drivetrain; the attachment; or environmental conditions. In one or some embodiments, at least the operating parameters of the drivetrain and the at least one ancillary unit of the drivetrain are incorporated in the optimized control since they can at least be directly ascertained in the prime mover.

In one or some embodiments, sensor devices may be assigned to the drivetrain that are configured to determine one or more aspects of the drivetrain, such as the operating parameters of the drivetrain. The sensor devices may, for example, any one, any combination, or all of: a rotational speed sensor; a torque sensor; a pressure sensor; or a force sensor. The sensor devices for determining operating parameters of the drivetrain may be assigned directly to the drivetrain or its components.

Moreover, additional sensor devices may be assigned to the prime mover and/or the attachment that are configured to determine operating information of the prime mover and/or the attachment. One of the sensor devices may, for example, be any one, any combination, or all of: a speed sensor; a tilt sensor; an optical sensor; or a positioning sensor.

The operating parameters of the drivetrain may include any one, any combination, or all of: the output of the at least one drive motor; the output of the gearbox or the gearbox load; the drive power of the at least one ancillary unit; any one or any combination of the at least one power take-off, the slip, the driving speed, the gearbox ratio, and/or the power flow in the hydraulic drive chain and/or in an optional electrical drivetrain.

Moreover, the operating parameters of the attachment may include any one, any combination, or all of: the nature of the attachment; the type of attachment; the lifting position; or the working depth of the attachment.

In particular, a functional model of the drivetrain may be saved in the memory unit that at least depicts part of the functional relationships of the drivetrain. Accordingly, the various operating situations of the prime mover may be modeled by using the functional model in order to achieve optimized controlling of the drivetrain by the engine droop governor in the particular operating situation and taking into account the chosen control strategy and/or optimization target variable(s). In particular, the functional model may have as inputs any one, any combination, or all of: the chosen control strategy (e.g., prime mover-specific strategies, and/or attachment-specific strategies; “efficiency” or “performance”; etc.); optimization target variables (e.g., “output per area”; “consumption per area”; “yield per area”; “cost per area”; or “work quality”); one or more aspects of the operating state of the prime mover and/or the attachment (e.g., data from the one or more sensors). The output of the functional model may comprise controlling one or more aspects of the drivetrain in order to optimize for the optimization target variable(s). Alternatively, pure black box models are contemplated that, for example, are based on artificial intelligence (AI) or neural networks or mixed forms in order to depict at least part of the functional relationships of the drivetrain. In one or some embodiments, the inputs and outputs for the functional model are the same as for the pure black box models.

In one or some embodiments, the functional model may be based on one or more characteristic maps. In one or some specific embodiments, at least one n-dimensional characteristic map may be assigned to the operating parameter of engine droop to depict the functional relationships of the drivetrain, wherein engine droop may be defined as the output variable of the at least one n-dimensional characteristic map. Thus, using the at least one n-dimensional characteristic map, the functional model may consider and depict even complex functional relationships with little computing effort. Characteristic curves of the n-dimensional characteristic map may be modified or adapted (e.g., dynamically adapted) to a particular situation in order to take into account all relationships in the drivetrain that may influence the control strategies, and/or the optimization target variable(s). In one or some embodiments, the characteristic curves may be adapted by the engine droop governor.

Furthermore, at least one or more operating parameters of the drivetrain and at least one ancillary unit of the drivetrain may be the input variables of the at least one n-dimensional characteristic map. Accordingly, the operating parameters of the output of at least one drive motor, output of the gearbox, gearbox load, drive power of the at least one ancillary unit and/or the at least one power take off, slip, power flow of the PTO train, and/or power flow in the hydraulic drivetrain and/or an electrical drivetrain may be input as the input variables.

In one or some embodiments, the at least one processor (e.g., the computing unit) may select the least one n-dimensional characteristic map depending on the selected control strategy and/or optimization target variable(s) and may be based on the ascertainment or determination of the engine droop.

According to one implementation, the computing unit may match the at least one n-dimensional characteristic map during operation, in particular cyclically, with the conditions of use of the prime mover, for example such that at least one n-dimensional initial characteristic map is saved in the memory unit, and during the initial ascertainment or determination of engine droop, the computing unit performs the ascertainment or determination based on the initial characteristic map. Thus, the driver assistance system may select, based on the at least one aspect of use of the prime mover (such as being in an initial state (e.g., initially operating the prime mover)), an n-dimensional initial characteristic map for use during an initial ascertainment of engine droop. Alternatively, or in addition, the driver assistance system may select, based on the at least one aspect of use of the prime mover (such as after the initial state (e.g., after initially operating the prime mover)), a different n-dimensional characteristic map for use after the initial ascertainment of engine droop. Still alternatively, a single n-dimensional characteristic map may be tailored in different stages of the operation, such as during initial operation and thereafter, thereby accessing the initial n-dimensional characteristic map and the different n-dimensional characteristic map.

In so doing, the computing unit may be configured to adapt the form of the initial characteristic map based on one or more aspects, such as adapting the form of the initial characteristic map to existing conditions of use by using measured parameters of the drivetrain, and/or the approach of sampling points in the initial characteristic map. If measured parameters are missing in the n-dimensional space of the initial characteristic map or only exist to an insufficient extent and they are not approached in the standard operation of the drivetrain, sampling points may be obtained or used instead. In particular, beginning from the initial characteristic map, the form of the characteristic map may be adapted to the current conditions of use by adjusting predefined operating points that represent sampling points in the characteristic map. In this regard, the characteristic map may be adapted or adjusted prior to operation of the prime mover.

Alternatively, or in addition, the characteristic map may be adapted or adjusted during operation of the prime mover. In particular, while the prime mover is operating, the precise form of the at least one n-dimensional characteristic map may be adapted to the current conditions of use by ascertaining or determining at least one of the parameters plotted in the characteristic map. When the prime mover is in working mode, the conditions of use may be subject to strong fluctuations that can be detected and taken into account immediately by the engine droop governor in order to optimize operation according to the chosen control strategy and/or the chosen optimization target variable(s). In one or some embodiments, “immediately” may mean that the engine droop governor can react within seconds to changes.

The engine droop governor, with the knowledge of the characteristic map, may automatically adjust the engine droop to set the engine droop so that the behavior of the drivetrain is optimized corresponding to the particular control strategy and/or the optimization target variable(s). In this case, the motor droop may form the manipulated variable.

Further, in one or some embodiments, a method for operating a prime mover, such as a tractor, is disclosed with a drivetrain as well as at least one attachment adapted to the drivetrain, wherein the drivetrain comprises at least one drive motor, a gearbox, at least one ancillary unit and at least one power take-off, wherein the drivetrain is controlled by a driver assistance system of the prime mover that is equipped with at least one processor, at least one memory, and an input/output unit, wherein the drivetrain is controlled by a motor droop governor of the driver assistance system that works based on a characteristic curve, wherein the drivetrain is controlled by the engine droop governor for optimized operation depending on selectable control strategies and/or optimization target variables saved in the memory unit. Through the method, the overall system, which may comprise (or consist) of the prime mover with the drivetrain and adapted attachment may be comprehensively optimized on the basis of an adjustment of the engine droop. In so doing, the method also may take into account the dispersions of efficiencies and/or operating behavior occurring in practice of the various components of the drivetrain that take into account the power emitted at one end by the drive motor to the drivetrain and the available tractive power at the other end of the drivetrain.

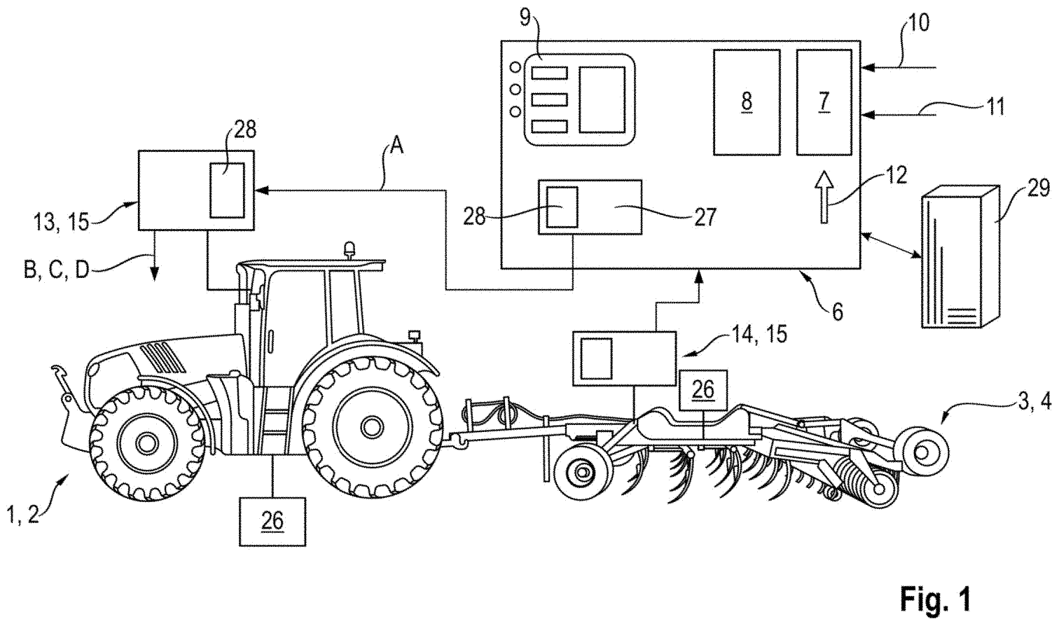

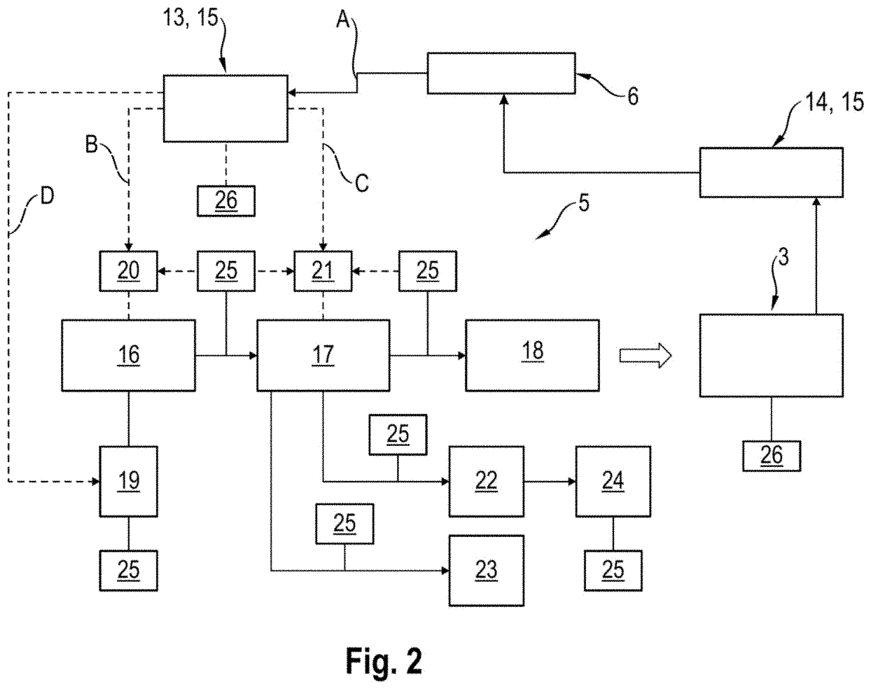

Referring to the figures, the agricultural machine assembly shown in FIG. 1 comprises a prime mover 1, which may comprise a tractor 2, and at least one attachment 3 adapted to or configured for connection to the prime mover 1. Various attachments 3 are contemplated. The attachment 3 illustrated in FIG. 1 is designed as a tillage machine 4 (e.g., a so-called grubber). It is further contemplated for the attachment 3 to be designed as, for example, a transport trailer, loading vehicle, windrow, tedder, mower, baler, other tillage machine such as a plow, sprayer, or manure spreader. The prime mover 1 comprises a drivetrain 5 that is schematically represented in FIG. 2. In a manner to be described in greater detail below, the prime mover 1 is assigned or includes a driver assistance system 6 for controlling the drivetrain 5. In one or some embodiments, the driver assistance system 6 comprises at least one computing unit 7 (which is an example of at least one processor), at least one memory unit 8 (which is an example of at least one memory) and one input/output unit 9.

Thus, the computing unit 7 may comprise any type of computing functionality and may include a processor, which may be resident therein. The memory unit 8 may comprise any type of memory. The processor (which may comprise a microprocessor, controller, PLA or the like) and the memory may comprise separate elements, or may be part of a single machine, which includes a microprocessor (or other type of controller) and a memory unit. The microprocessor and memory unit are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, circuitry associated with computing unit 7, may store in or access instructions from memory for execution, or may implement its functionality in hardware alone. The instructions, which may comprise computer-readable instructions, may implement the functionality described herein (such as the data analytics) and may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described herein or illustrated in the drawings. Thus, computing unit 7 may access data, which may be stored in memory unit 8, in order to perform the analysis discussed herein.

The computing unit 7 processes information 10 generated by any one, any combination, or all of: machine-internal sensor devices 25, 26 of the prime mover 1 and/or the attachment 3; external information 11; or information 12 savable in the computing unit 7. Moreover, the prime mover 1 and the attachment 3 may be assigned one or more control devices 13, 14 for controlling and regulating the prime mover 1 and/or the particular attachment 3. It is contemplated for the prime mover 1 and the attachment 3 to be assigned either separate control devices 13, 14 for controlling, or a joint control unit 15. The joint control unit 15 may then be positioned either on the prime mover 1 or the attachment 3. It is contemplated that the input/output unit 9 may also be designed as mobile so that it can be carried by an operator of the prime mover 1. Remote operation of the driver assistance system 6 by remote access is also contemplated. The driver assistance system 6 may also be designed based on a data cloud in that data are retrievably and editably saved not on the memory unit 8 but at least partially on an external, spatially remote memory device of an external server 29.

The driver assistance system 6 comprises an engine droop governor 27 that operates based on a characteristic curve and effectuates optimization of the drivetrain of the prime mover 1. In the simplest case, this is effectuated in that the engine droop governor 27 generates control signals A that are supplied to at least the control device 13 or the control unit 15 of the prime mover 1 and effectuate the control of the components of the drivetrain 5 of the prime mover 1 there by generating corresponding control signals B, C, D.

FIG. 2 schematically portrays the drivetrain 5 of the prime mover 1. The drivetrain 5 comprises at least one drive motor 16, a gearbox 17, at least one power take-off 18 and the at least one ancillary unit 19. The drive motor 16 may be designed as an internal combustion engine. Further, the drive motor 16 may be controlled by an engine control unit 20. The gearbox 17 may be designed as a power shift gearbox or continuously variable gearbox. The gearbox 17 may be controlled by a gearbox control unit 21. The at least one power take-off 18 may be designed as a power take-off shaft that serves to drive the attachment 3. The at least one ancillary unit 19 may be designed as an engine fan that is part of a cooling device of the drive motor 16. Moreover, the drivetrain 5 can have a hydraulic drivetrain 22 and/or an electric drivetrain 23. In this case, for example a hydraulic pump and a hydraulic motor or a generator as well as an electric motor can form other ancillary units 19 of the drivetrain 5. The hydraulic drivetrain 22 serves, for example, to operate a lifter 24 with which the attachment 3 is adapted to the prime mover 1.

Sensor devices 25 may be assigned to the drivetrain 5 and may be configured to determine operating parameters of the drivetrain 5, or respectively its different components. The sensor devices 25 may, for example, be any one, any combination, or all of: a rotational speed sensor; a torque sensor; a pressure sensor; or a force sensor. The sensor devices 25 for determining operating parameters of the drivetrain 5 may be assigned directly to the drivetrain 5. Moreover, additional sensor devices 26 may be assigned to the prime mover 1 and/or the attachment 3 that are configured to determine specific operating information of the prime mover 1 and/or the attachment 3. One of the additional sensor devices 26 can, for example, be any one, any combination, or all of: a speed sensor; a tilt sensor; an optical sensor; or a positioning sensor. Moreover, at least one of the additional sensor devices 26 may be configured to receive and/or to determine satellite-based or satellite-supported information such as geo-data or vegetation data. The sensor devices 25 of the drivetrain as well as the other sensor devices 26 of the prime mover 1 and/or the attachment 3 may transmit the generated information 10 indirectly or directly to the driver assistance system 6. The computing unit 7 is configured to evaluate the information 10. The communication between the engine control unit 20, the gearbox control unit 21, the sensor devices 25, 26 as well as the separate control devices 13, 14 or the control unit 15 and the driver assistance system 6 may be performed via one or more communication paths, such as for example a bus system of the prime mover 1 or the attachment 3, and/or a wireless communication system.

In one or some embodiments, the drivetrain 5 together with the driver assistance system 6 forms the engine droop governor 27. In this case, the driver assistance system 6 may comprise a set of rules 28 assigned to the engine droop governor 27 that effectuates optimization of the performance of the prime mover 1. Moreover, it is contemplated for the set of rules 28, which are used for optimizing the performance of the drivetrain 5, to be saved in the control device 13 assigned to the prime mover 1 and which may be designed as a job or dedicated computer. Moreover, it is contemplated that the set of rules 28 may also be saved centrally on an external server 29, or any other backend system, such as a data cloud-based system, and may be retrieved by a communication link between the prime mover 1 and the server 29.

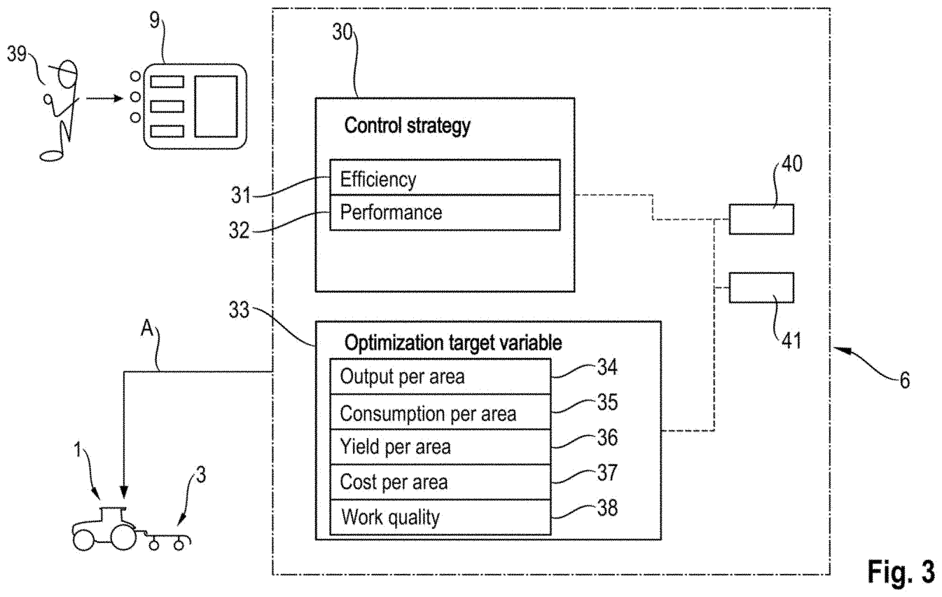

The depiction in FIG. 3 shows a detailed view of the driver assistance system 6 of the prime mover 1, such as the tractor 2, wherein the visualization, operational and structural aspects are combined in one in the same depiction. To optimize the performance of the drivetrain 5 of the prime mover 1, the driver assistance system 6 comprises selectable control strategies 30, wherein the selectable control strategies 30 are prime mover-specific strategies, attachment-specific strategies, and/or a combination of both. Taking into account the adapted attachment 3, efficient optimization of the drivetrain 5 of the prime mover 1 results when the selectable control strategies 30 comprise at least one of the control strategies of “efficiency” 31 and “performance” 32. With the “efficiency” 31 control strategy, optimization of fuel consumption per unit area is carried out, i.e., operation of the drive motor 16 near the minimum possible fuel consumption taking into account all components of the entire drivetrain 5. With the control strategy of “performance” 32, an optimization of output per area is carried out, wherein the operating point lies near the maximum engine output, taking into account the parameters of the drivetrain 5.

Moreover, the driver assistance system 6 for optimizing the performance of the drivetrain 5 of the prime mover 1 comprises selectable optimization target variables 33. The optimization target variables 33 can be selected by an operator 39 alternatively or in addition to the control strategies 30.

The driver assistance system 6 can also be configured such that it can either be operated in a dialog mode 40 with the operator 39 or in an automatic mode 41. In both cases, communication, the dialog with the operator 39, occurs in natural language.

The optimization target variables 33 can be the “output per area” 34, “consumption per area” 35, “yield per area” 36, cost per area” 37 and/or “work quality” 38. The optimization target variable 33 of “performance per area” 34 can for example primarily concern the increase of the worked area and/or processed bulk of agricultural goods per unit time (ha/h). The optimization target variable 33 of “consumption per area” 35 seeks to minimize the fuel consumption per unit area (1/ha). The optimization target variable 33 of “yield per area” 36 seeks to maximize the yield. The optimization target variable 33 of “cost per area” 37 can for example primarily include accruing personnel costs, fuel costs, wear costs, operating hours, etc. The optimization target variable 33 of “work quality” 38 prioritizes for example the admixture of crop residue, crumbling, reconsolidation, feed quality, etc. in controlling the drivetrain 5.

The drivetrain 5 together with the driver assistance system 6 forms the engine droop governor 27 in that the computing unit 7 of the driver assistance system 6 is configured to ascertain or determine parameters of the drivetrain 5 autonomously in order to implement the selected control strategy 30 and/or optimization target variable 33, and to specify them to the drivetrain 5, preferably the drive motor 16 and/or the gearbox 17. This can be done by transmitting the control signals A to the control device 13 or control unit 15 that then transmits corresponding control signals B, C to the engine control unit 20 and/or the gearbox control unit 21.

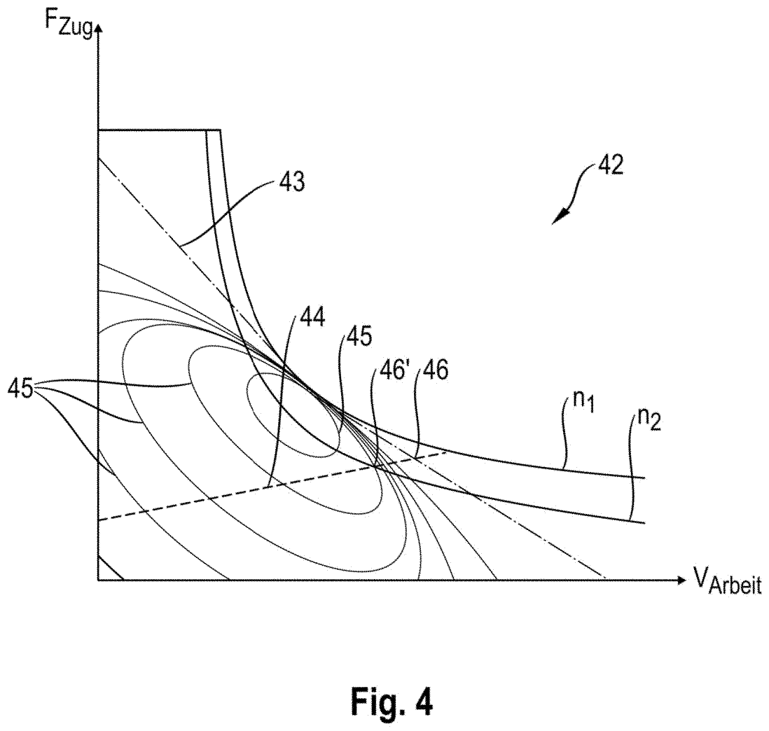

The engine droop governor 27 is configured for optimized controlling of the drivetrain 5 depending on the selectable control strategies 30 and/or optimization strategies 33 saved in the memory unit 8. The engine droop governor 27 of the driver assistance system 6 works based on a characteristic curve. In this regard, at least one n-dimensional characteristic map 42 is saved in the memory unit 8 that will be further explained with reference to the depiction according to FIG. 4. The at least one n-dimensional characteristic map 42 is part of the set of rules 28. In this regard, the engine droop governor 27 varies the engine rotational speed or engine droop n1, n2 at full load or the shifting rotational speed and thereby specifies the “consumption per area” 35—fuel consumption per area (1/ha)—and/or the “performance per area” 34—worked area per hour (ha/h)—by the engine rotational speed at full load or shifting rotational speed. In this regard, signals such as the engine rotational speed or engine droop n1, n2 detected by the sensor devices 25 are evaluated by the engine droop governor 27 and saved in the n-dimensional characteristic map 42.

FIG. 4 shows an example of an n-dimensional characteristic map 42 for controlling the drivetrain 5. A functional model of the drivetrain 5 is saved in the memory unit 8 and depicts at least part of the functional relationships of the drivetrain 5. Also contemplated are pure black box models that, for example, are based on artificial intelligence (AI) or neural networks or mixed forms in order to depict at least part of the functional relationships of the drivetrain 5. The at least one n-dimensional characteristic map 42 is assigned to the operating parameter of engine droop n1, n2 to depict the functional relationships of the drivetrain 5, wherein the engine droop n1, n2 is defined as the output variable of the at least one n-dimensional characteristic map 42.

The working speed V_{Arbeit} is plotted against the tractive force F_{Zug} as input variables in the characteristic map 42. The output variable forms the engine droop n1, n2. Moreover, reference sign 43 identifies the tractive force characteristic curve of the prime mover, and reference sign 44 identifies the tractive force characteristic curve of the attachment 3 that are depicted in the characteristic field 42 as examples. Moreover, lines 45 are shown in the background as constant specific fuel consumption in the form of so-called “shell curves”. The intersection of the tractive force characteristic curve 43 of the attachment 3 and the prime mover 1 defines an operating point 46 that results at full load with different adjustments of the engine droop. The lines 45 of constant specific fuel consumption may be calculated for a specific operating state given a known configuration of the drivetrain 5. A specific operating state may be established by operating parameters of the drivetrain 5, the at least one ancillary unit 19 of the drivetrain 5, the attachment 3 and/or environmental conditions. The operating parameters of the drivetrain 5, the at least one ancillary unit 19, the attachment 3, the hydraulic drivetrain 22, the electric drivetrain 23 and/or environmental conditions form the parameters to be considered for the optimized control of the drivetrain 5.

The operating parameters of the drivetrain 5 may comprise any one, any combination, or all of the following: the output power of the least one drive motor 16, the output power of the gearbox 17 or the gearbox load, the drive power of the at least one ancillary unit 19 and/or the at least one power take-off 18, the slip, the driving speed, the gearbox ratio and/or the power flow in the drivetrain of the power take-off 18 in the hydraulic drivetrain 22 or in the electric drivetrain 23. Accordingly, for example, the drive power of at least one ancillary unit 19 may be determined from the difference between the output power of the drive motor 16 and the output power of that gearbox 17 taking into account the characteristic map of the gearbox efficiency.

Moreover, the operating parameters of the attachment 3 may include the nature and/or type of attachment 3, the lift position and/or the working depth of the attachment 3.

With the control strategy of “efficiency”, an optimization of fuel consumption per unit area is performed, wherein the operating point 46 in the n-dimensional characteristic map 42 lies near (or nearest) the least possible fuel consumption, taking into account the parameters of the drivetrain 5 (e.g., the computing unit of the driver assistance system determines the operating point 46 nearing the least possible fuel consumption). With the control strategy of “performance”, an optimization of output per area is carried out, wherein the operating point 46 in the n-dimensional characteristic map 42 lies near the maximum engine output, taking into account the parameters of the drivetrain 5. To accomplish this, the engine droop n1, n2 at full load, or the shifting rotational speed of the gearbox 17 is varied taking into account the parameters of the drivetrain 5 corresponding to the particular control strategy.

According to the characteristic map 42 shown as an example in FIG. 4, the optimization target variable of “consumption per area” (one example of an optimized parameters) is optimized by the engine droop governor 27 such that the engine droop n1 is switched to engine droop n2 so that an operating point 46′ is adjusted that lies on the characteristic curve 44 of the required tractive force of the attachment 3 at full load closer to the point of the minimum possible specific fuel consumption in the characteristic map 42.

The computing unit 7 may match the at least one n-dimensional characteristic map 42 during operation, in particular cyclically such as at predetermined intervals or responsive to determining that the operation of the prime mover and/or the attachment changes, with the conditions of use of the prime mover 1. In this case, preferably at least one n-dimensional initial characteristic map 42′ may be saved in the memory unit 8. Accordingly, the computing unit 7 of the driver assistance system 6 can undertake the determination of the first determination of the engine droop n1, n2 based on the initial characteristic map 42′.

Moreover, the computing unit 7 can be configured to perform an adaptation of the form of the initial characteristic map 42′ to existing conditions of use by using measured operating parameters, or the approach of sampling points in the initial characteristic map 42′. Starting from the initial characteristic map 42′, the form of the characteristic map 42 can be adapted to the current conditions of use by adjusting predefined operating points that represent sampling points in the characteristic map 42 which are not determined in the normal operation of the drivetrain 5. In this regard in a first step, rated values or respectively operating parameters are acquired using data generated from the particular sensor devices 25, 26 and preprocessed by the computing unit 7. If the rated values such as rotational speeds, forces, and slip are more or less stationary, they are entered into the n-dimensional initial characteristic map. If rated values determined by the sensor devices 25, 26 are missing in the n-dimensional space of the initial characteristic map 42′ because they do not occur during regular field travel or are only insufficiently present since they are not approached during standard operation of the drivetrain, sampling points may be approached instead. The second step includes the testing and adaptation of the functional model of the drivetrain 5 based on changes in the current conditions of use that are in turn determined by the operating parameters.

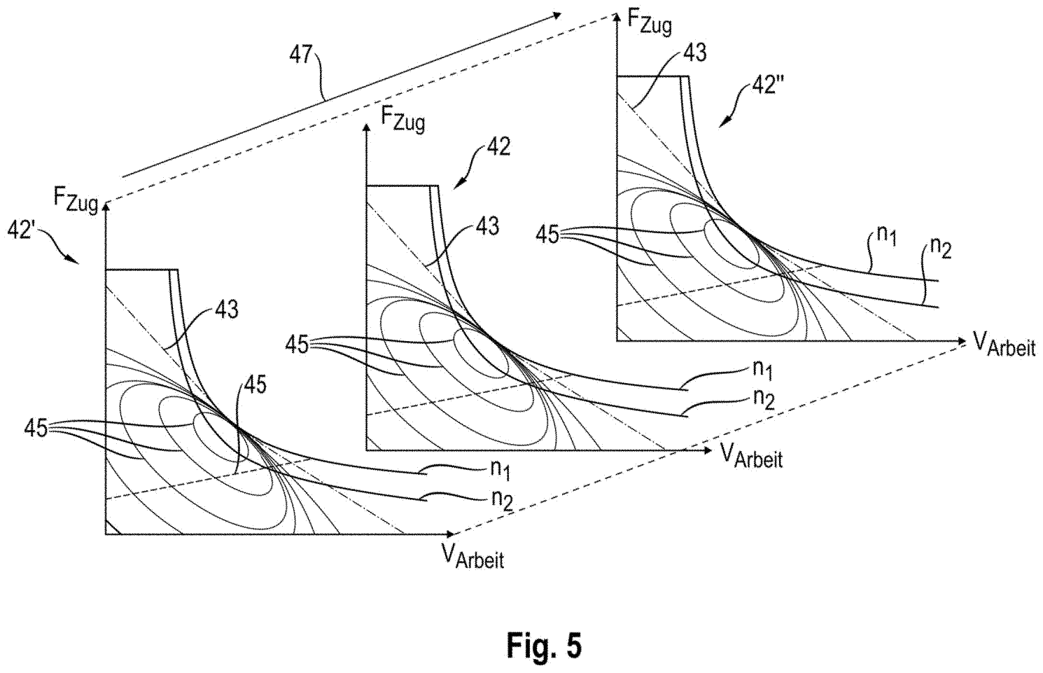

The depiction in FIG. 5 shows an example of an n-dimensional initial characteristic map 42′ that is adapted based on a change to at least one operating parameter in the drivetrain 5. The operating parameter is, for example, the rotational speed of the ancillary unit 19 designed as an engine fan which rises during operation depending on the load on the drive motor 16, as illustrated in FIG. 5 by the arrow 47. The increase as indicated by arrow 47 in the rotational speed of the engine fan leads to an adaptation of the initial characteristic map 42′ to characteristic map 42 or characteristic map 42″.

The above description of FIGS. 1 to 5 illustrates that for example the control strategies 30 and/or the optimization target variables 33 are based not only on a fuel consumption characteristic map specific to the particular drive motor 16, but also consider one or more components of the drivetrain 5. Accordingly, operation of the drivetrain 5 may be improved (e.g., may be optimized as a whole) by the engine droop governor 27 based on an adjustment of the engine droop n1, n2. In so doing, the dispersions of efficiencies and/or operating behavior of the components of the drivetrain 5 that occur in practice may be considered by the driver assistance system 6 and the engine droop governor 27.

It is intended that the foregoing detailed description be understood as an illustration of selected forms that the invention can take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of reference numbers

| | |
|---|---|
| 1 | Prime mover |
| 2 | Tractor |
| 3 | Attachment |
| 4 | Tillage machine |
| 5 | Drivetrain |
| 6 | Driver assistance system |
| 7 | Computing unit |
| 8 | Memory unit |
| 9 | Input/output unit |
| 10 | Information |
| 11 | External information |
| 12 | Information |
| 13 | Control device |
| 14 | Control device |
| 15 | Control unit |
| 16 | Drive motor |
| 17 | Gearbox |
| 18 | Power take-off |
| 19 | Ancillary component |
| 20 | Engine control module |
| 21 | Gearbox control module |
| 22 | Hydraulic drivetrain |
| 23 | Electric drivetrain |
| 24 | Lifter |
| 25 | Sensor apparatus |
| 26 | Sensor apparatus |
| 27 | Engine droop governor |
| 28 | Set of rules |
| 29 | Server |
| 30 | Control strategy |
| 31 | Efficiency |
| 32 | Performance |
| 33 | Optimization target variable |
| 34 | Output per area |
| 35 | Consumption per area |
| 36 | Yield per area |
| 37 | Cost per area |
| 38 | Work quality |
| 39 | Operator |
| 40 | Dialog mode |
| 41 | Automatic mode |
| 42 | Characteristic map |
| 42′ | Initial characteristic map |
| 42″ | Adapted characteristic map |
| 43 | Tractive force characteristic curve of 1, 2 |
| 44 | Tractive force characteristic curve of 3, 4 |
| 45 | Line of constant fuel consumption |
| 46 | Operating point |
| 46′ | Operating point |
| 47 | Arrow |
| A | Control signal |
| B | Control signal |
| C | Control signal |
| D | Control signal |
| F_{Zug} | Tractive force of 1, 2 |
| n₁ | |
| n₂ | |
| V_{Arbeit} | Working speed |

1. A prime mover configured for connection with at least one attachment, the prime mover comprising:
a drivetrain, wherein the drivetrain comprises at least one drive motor, at least one gearbox, at least one power take-off, and at least one ancillary unit;
a driver assistance system configured to control the drivetrain, the driver assistance system comprising at least one processor, a memory, and an input/output device;
wherein the driver assistance system comprises an engine droop governor configured to operate based on a characteristic curve, and
wherein the engine droop governor is configured for optimized control of the drivetrain depending on one or both of at least one selectable control strategy saved in the memory or at least one optimization target variable.

2. The prime mover of claim 1, wherein the engine droop governor is configured for optimized control of the drivetrain depending on the selectable control strategies saved in the memory.

3. The prime mover of claim 1, wherein the engine droop governor is configured for optimized control of the drivetrain depending on the optimization target variables.

4. The prime mover of claim 1, wherein the driver assistance system is configured to input the at least one selectable control strategy from an operator via the input/output device;
wherein the at least one selectable control strategy is selected from a plurality of available control strategies stored in the memory;
wherein the driver assistance system is configured to input the at least one optimization target variable from the operator via the input/output device;
wherein the at least one optimization target variable is selected from a plurality of optimization target variables stored in the memory;
wherein the drivetrain and the driver assistance system form the engine droop governor;
wherein the processor is configured to ascertain parameters of the drivetrain autonomously in order to:
implement one or both of the at least one selectable control strategy or at least one optimization target variable; and
specify them to the drivetrain.

5. The prime mover of claim 4, wherein the plurality of available control strategies comprise a first type of control strategies and a second type of control strategies;
wherein the first type of control strategies comprises prime mover-specific strategies; and
wherein the second type of control strategies comprises attachment-specific strategies.

6. The prime mover of claim 4, wherein the plurality of available control strategies comprise efficiency and performance.

7. The prime mover of claim 4, wherein the plurality of optimization target variables comprise output per area, consumption per area, yield per area, cost per area and work quality.

8. The prime mover of claim 1, wherein the engine droop governor is configured to optimize one or more parameters for optimized control of the drivetrain, wherein the one or more parameters are of at least one of: the at least one ancillary unit of the drivetrain; the attachment; or environmental conditions.

9. The prime mover of claim 1, wherein the engine droop governor is configured to optimize parameters for optimized control of the drivetrain, wherein the parameters are of the at least one ancillary unit of the drivetrain, the attachment, and environmental conditions.

10. The prime mover of claim 1, further comprising one or more sensors configured to determine operating parameters of the drivetrain.

11. The prime mover of claim 10, further comprising one or more sensors configured to determine operating information of the prime mover and the attachment.

12. The prime mover of claim 9, wherein the optimized parameters include:
at least one optimized parameter for optimized control of the drivetrain include at least one of an output of the at least one drive motor, an output of the at least one gearbox or a gearbox load, or drive power of the at least one ancillary unit; and
at least one optimized parameter for power take off, slip, driving speed, gearbox ratio, or power flow in a hydraulic drivetrain.

13. The prime mover of claim 9, wherein the optimized parameters of the attachment include nature or type of attachment, lifting position and working depth of the attachment.

14. The prime mover of claim 1, wherein the memory is configured to save a functional model of the drivetrain that depicts at least part of functional relationships of the drivetrain; and
wherein the engine droop governor is configured to use the functional model of the drivetrain for optimized control of the drivetrain.

15. The prime mover of claim 1, wherein at least one n-dimensional characteristic map is assigned to an operating parameter of engine droop to depict functional relationships of the drivetrain;
wherein the engine droop is defined as an output variable of the at least one n-dimensional characteristic map; and
wherein the engine droop governor is configured to use the output variable of the at least one n-dimensional characteristic map for optimized control of the drivetrain.

16. The prime mover of claim 15, wherein at least one or more operating parameters of the drivetrain and the at least one ancillary unit of the drivetrain are input variables of the at least one n-dimensional characteristic map.

17. The prime mover of claim 16, wherein the driver assistance system is configured to input the at least one selectable control strategy from an operator via the input/output device;
wherein the at least one selectable control strategy is selected from a plurality of available control strategies stored in the memory; and
wherein the processor is configured to select the at least one n-dimensional characteristic map depending on the at least one selectable control strategy and is based on determination of the engine droop.

18. The prime mover of claim 17, wherein the driver assistance system is configured is configured to dynamically match the at least one n-dimensional characteristic map with conditions of use of the prime mover.

19. The prime mover of claim 18, wherein the processor is configured to select at least one n-dimensional initial characteristic map responsive to determining that the prime mover is in an initial ascertainment of engine droop in order for the engine droop governor to optimize control of the drivetrain during the initial ascertainment of engine droop; and
wherein the processor is configured to use a different n-dimensional characteristic map responsive to determining that the prime mover is operating after the initial ascertainment of engine droop in order for the engine droop governor to optimize control of the drivetrain after the initial ascertainment of engine droop.

20. The prime mover of claim 19, wherein the processor, in order to generate the different n-dimensional characteristic map, is configured to adapt the at least one n-dimensional initial characteristic map to one or more existing conditions of use by using measured parameters of the drivetrain, or by sampling points in the at least one n-dimensional initial characteristic map.

21. A driver assistance system for use with a prime mover, the driver assistance system comprising:
a memory;
an input/output device; and
at least one processor in communication with the memory and the input/output device;
wherein the at least one processor is configured to control a drivetrain of the prime mover, the drivetrain comprising at least one drive motor, at least one gearbox, at least one power take-off, and at least one ancillary unit;
wherein the driver assistance system comprises an engine droop governor configured to operate based on a characteristic curve, and
wherein the engine droop governor is configured for optimized control of the drivetrain depending on one or both of at least one selectable control strategy saved in the memory or at least one optimization target variable.

22. A method comprising:
in a prime mover, the prime mover including: a drivetrain, wherein the drivetrain comprises at least one drive motor, at least one gearbox, at least one power take-off, and at least one ancillary unit; a driver assistance system configured to control the drivetrain, the driver assistance system comprising at least one processor, a memory, and an input/output device:
an engine droop governor of the driver assistance system controlling the drivetrain based on a characteristic curve, wherein the engine droop governor controls the drivetrain depending on one or both of selectable control strategies or optimization target variables saved in the memory.
